(19) United States
(12) Patent Application Publication
(10) Pub. No.: US 2005/0021520 A1
(43) Pub. Date: Jan. 27, 2005

(54) Method for controlling access rights to data stored in a hand portable device and a hand portable device for providing access to stored data

(75) Inventors: Peter Dam Neilsen, Kgs Lyngby (DK); Christian Kraft, Hvidovre (DK)

Correspondence Address: HARRINGTON & SMITH, LLP, 4 RESEARCH DRIVE, SHELTON, CT, 06484-6212, US

(73) Assignee: Nokia Corporation

(21) Appl. No.: 10/627,117

(22) Filed: Jul. 24, 2003

(51) Int. Cl. G06F 17/30

(52) U.S. Cl. 707/9

(57) ABSTRACT

A method for controlling access rights to data stored in a hand portable device, comprising: a) storing a plurality of data assemblages in the hand portable device; b) accessing a first data assemblage; c) in response to step b), automatically restricting subsequent access to the first data assemblage using a first security mechanism; d) accessing a second data assemblage; and e) in response to step d), automatically restricting subsequent access to the second data assemblage using the first security mechanism.

### FIELD OF THE INVENTION

Embodiments of the invention relate to methods for controlling access rights to data stored in a hand portable device and hand-portable devices for providing controlled access to stored data.

### BACKGROUND TO THE INVENTION

When a device is used by a person other than its owner, it would be desirable to prevent that person accessing data stored on that device. Such data may be personal to the owner (personal data).

However, such protection should not interfere unduly with the owner's enjoyment of the device.

### BRIEF SUMMARY OF THE INVENTION

According to one embodiment there is provided a method for controlling access rights to data stored in a hand portable device, comprising:
a) storing a plurality of data assemblages in the hand portable device
b) accessing a first data assemblage;
c) in response to step b), automatically restricting subsequent access to the first data assemblage using a first security mechanism;
d) accessing a second data assemblage; and
   e) in response to step d), automatically restricting subsequent access to the second data assemblage using the first security mechanism.

According to another embodiment there is provided a method for controlling access rights to data stored in a hand portable device, comprising:
a) storing data in the hand portable device;
b) accessing the stored data; and
c) in response to step b), automatically restricting further access to the data.

According to another embodiment there is provided a method for controlling access rights to data stored in a hand portable device, wherein a data assemblage containing data for display as displayable content, is automatically password protected after the content is first displayed.

According to another embodiment there is provided a method for controlling access rights to data stored in a hand portable device, comprising:
a) storing a plurality of data assemblages in the hand portable device;
b) storing at least one data attribute for each data assemblage;
c) changing the data attribute of a first data assemblage from a first type to a second type; and
d) in response to step c), automatically restricting further access to the first data assemblage using a first security mechanism.

According to another embodiment there is provided a hand-portable device, for providing controlled access to stored data assemblages, comprising:
user input means for user input of a password;
a memory for storing a first data assemblage and a second data assemblage;
access means for enabling a user to access the first data assemblage and the second data assemblage; and
access control means arranged to detect access to the first data assemblage and automatically restrict subsequent access to the first data assemblage using a first security mechanism involving the password and arranged to detect access to the second data assemblage and automatically restrict subsequent access to the second data assemblage using the first security mechanism involving the password.

According to another embodiment there is provided a hand-portable device, for providing controlled access to stored data assemblages, comprising:
user input means for user input of a password;
a memory for storing data;
access means for enabling a user to access the data; and
access control means arranged to detect access to the data and automatically restrict subsequent access to the data using a first security mechanism involving the password.

According to another embodiment there is provided a hand-portable device, for providing controlled access to stored data assemblages, comprising:
user input means for user input of a password;
a memory for storing a plurality of data assemblages and a plurality of associated respective attributes;
access means for enabling a user to access a stored data assemblage; and
access control means arranged to automatically restrict subsequent access to a first data assemblage using a first security mechanism, after the data attribute of the first data assemblage changes from a first type to a second type.

In one embodiment, the first type of attribute indicates that the data assemblage has not yet been accessed using the device and the second type of file attribute indicates that the data assemblage has been accessed using the device.

In another embodiment, the first type of file attribute indicates that the data assemblage has been received and is available for access and the second type of file attribute indicates that the data assemblage was not accessed when received.

Embodiments of the invention may be used to password protect individual files automatically without having to transfer them to a password protected folder.

### BRIEF DESCRIPTION OF THE DRAWINGS

For a better understanding of the present invention and to understand how the invention can be practised reference will now be made by way of example only to the accompanying drawings of embodiments of the invention in which:

FIG. 1 illustrates a hand-portable device 10 for providing controlled access to stored personal user data; and

FIG. 2 schematically illustrates a method for controlling access rights to personal user data stored in a hand portable device 10.

### DETAILED DESCRIPTION OF EMBODIMENT(S) OF THE INVENTION

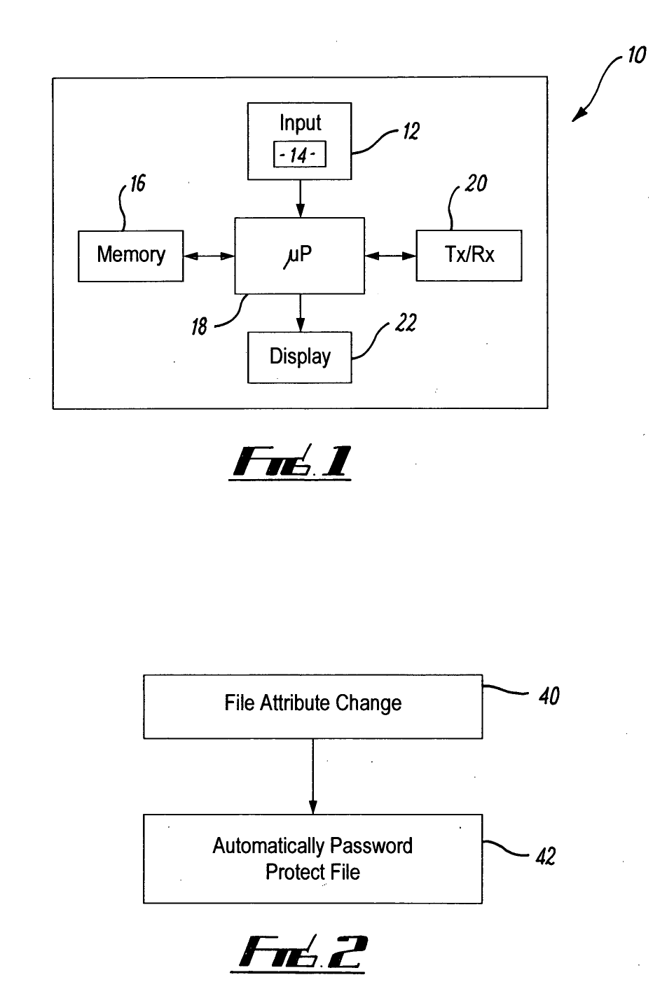

FIG. 1 illustrates a hand-portable device 10 for providing controlled access to stored data. In this embodiment, the hand-portable device 10 is a mobile cellular telephone, however, in other embodiments it may be another type of electronic device, such as a personal digital assistant (PDA).

The mobile telephone 10 comprises a user input 12, a memory 16; processor 18; a radio transceiver 20; and a display 22. Only the features necessary to explain the operation of the following described embodiments of the invention have been illustrated. Alternative embodiments may have alternative features.

The processor 18 is connected to receive commands from the user input 12, to read from and write to the memory 16, to control the display 22 and to send data to and receive data from the radio transceiver 20. The processor 18 operates under the control of computer program instructions stored in the memory 16. These computer program instructions enable the processor 18 to control the telephone 10 as described below.

The memory 16, in this example, stores a plurality of files each of which contains personal user data. One or more of these files may have been downloaded to the telephone 10 via the radio transceiver 20 e.g. SMS messages, MMS messages. One or more of the files may relate to personal communications using the radio transceiver 20 e.g. instant messaging histories. One or more of the files may have been captured using the telephone 10 and may be of a personal nature e.g. picture files; audio files; and video files. One or more of the files may provide personal information about the user such as internet bookmarks.

The memory 16 may additionally store other data such as files of a non-personal nature e.g. downloaded ringtones, applications etc.

The processor 18 enables a user to access the user personal data contained in a stored file. The processor is able to read the file from the memory 16 and display the user personal data on the display 22.

The processor 18 additionally controls access to the stored files. It determines whether a password should be entered before a file can be accessed. Typically a password could be requested if the file contains user personal data.

Preferably, the processor 18 detects when an attribute of a stored file, containing user personal data, changes from a first type to a second type. In response to such a detection, the processor 18 may automatically password protect the stored file, such that access to user personal data contained in the stored file requires the input of a password by a user.

In one embodiment, the first type of file attribute indicates that the file has not yet been accessed using the telephone 10 and the second type of file attribute indicates that the file has been accessed using the telephone 10. For example, if the file stores the content of an SMS message received by the mobile telephone 10, the first type of file attribute indicates that the message is unread and the second type of file attribute indicates that the message has been read. Thus the processor 18 would automatically password protect all received SMS messages after they have been read. Further access to read the messages would therefore require the user to enter the correct password.

In another embodiment, the first type of file attribute indicates that the file has just been received and is available for access and the second type of file attribute indicates that access was not made when the file was received. For example, if the file stores the content of an SMS message just received by the mobile telephone 10 via the radio transceiver 20, the first type of file attribute indicates that the message is received and available to be read. Typically an indication will be presented on the display informing the user that a new message has been received. The user can then choose to immediately access that message or to wait and access it at a later time. If the user does not access the message, the file attribute is changed to the second type of file attribute that indicates that the message is unread. Thus the processor 18 may automatically password protect all received SMS message, which have not been read on receipt. Access to read the messages would require the user to enter the correct password.

It should be appreciated that these embodiments, provide for the automatic password protection of a received message without slowing down the reading of unread or newly received messages respectively. This obviates the need for cumbersome password entry before every newly received message is read for the first time.

The password protection of a file may be achieved by recording in association with a file an indication that the file is accessible with a password. For example, the memory 16 may store a database that records in association with each of a plurality of files an indication that a file is accessible with/without a password.

The password may be any suitable security device. For example it may be a secret, a biometric, or a combination of numeric, alpha or alphanumeric characters. The same password is preferably shared between all of the automatically protected files.

The user input 12 includes a key pad 14 that can be used for alphanumeric character entry. This user input 12 is used by a user to enter the password.

The automatic password protection operates to automatically protect user personal data. The processor 18 may be arranged to discriminate between files that contain user personal data and may be suitable for automatic password protection and those files that do not contain user personal data and are not suitable for automatic password protection. For example, the discrimination may occur on the basis of the file content, which may be determined from e.g. a MIME extension.

Files that are suitable for automatic password protection include:
a) communication files that have been downloaded to the telephone 10 via the transceiver 20 such as SMS messages, MMS messages.
b) personal communication files such as instant messaging histories.
c) files that are captured using the telephone 10 and may be of a personal nature such as picture files; audio files; and video files.
d) files that provide personal information about the user such as Internet bookmarks.

The processor 18 is operable to provide a user of the telephone 10, with an option for disabling or enabling the automatic password protection feature described above. Furthermore, the operation of the processor 18 to effect automatic password protection may be configured by a user, using the user input 12.

For example, the user may:
a) specify the shared password; and/or
b) specify the file attribute change that triggers automatic password protection; and/or
c) specify the file type(s) for which automatic password protection is available.

FIG. 2 schematically illustrates the method described above with reference to FIG. 1. The method controls access rights to personal user data stored in a hand portable device 10.

At step 40, the attribute for a file, containing personal user data, changes from a first type to a second type. At step 42, the file is automatically password protected against access.

The file may be one of a plurality of defined types. The types of file may be specified by the user.

A common password may be used for multiple files automatically protected using this method and the shared password may be specified and changed by the user.

The attribute change may indicate, for example, that a file has been accessed or that an opportunity to access the file has been missed or declined.

Although embodiments of the present invention have been described in the preceding paragraphs with reference to various examples, it should be appreciated that modifications to the examples given can be made without departing from the scope of the invention as claimed. For example although the preceding description refers to data files, the invention may be used with any type of data assemblage including files.

Whilst endeavouring in the foregoing specification to draw attention to those features of the invention believed to be of particular importance it should be understood that the Applicant claims protection in respect of any patentable feature or combination of features hereinbefore referred to and/or shown in the drawings whether or not particular emphasis has been placed thereon.

1. A method for controlling access rights to data stored in a hand portable device, comprising:
a) storing a plurality of data assemblages in the hand portable device;
b) accessing a first data assemblage;
c) in response to step b), automatically restricting subsequent access to the first data assemblage using a first security mechanism;
d) accessing a second data assemblage; and
e) in response to step d), automatically restricting subsequent access to the second data assemblage using the first security mechanism.

2. A method as claimed in claim 1, further comprising subsequent to step c), requesting entry of a first password to enable access to the first data assemblage and subsequent to step e), requesting entry of the first password to enable access to the second data assemblage.

3. A method as claimed in claim 1 or 2, further comprising, before step a), receiving the first data assemblage at the hand portable device and before step d), receiving the second data assemblage at the hand portable device.

4. A method as claimed in claim 1, wherein the access at step b) is a first access to the first data assemblage by the hand portable device and wherein the access at step e) is a first access to the second data assemblage by the hand portable device.

5. A method as claimed in claim 1, further comprising: discriminating the type of a data assemblage, wherein the automatic restriction of further access at step c) is enabled only for a first data assemblage of a defined type or types and the automatic restriction of further access at step e) is enabled only for a second data assemblage of the defined type or types.

6. A method as claimed in claim 5, further comprising user specification of the defined type(s) for which automatic restriction of further access is enabled.

7. A method as claimed in claim 1 further comprising: user specification of a password for use in the first security mechanism.

8. A method as claimed in claim 1, wherein the first data assemblage is one of: a SMS message, a MMS message, an instant messaging history, a picture file; an audio file; a video file; or a collection of bookmarks and wherein the second data assemblage is one of: a SMS message, a MMS message, an instant messaging history, a picture file; an audio file; a video file; or a collection of bookmarks.

9. A method as claimed in claim 1 wherein the first data assemblage and/or the second data assemblage is/are created in the device.

10. A method for controlling access rights to data stored in a hand portable device, comprising:
a) storing data in the hand portable device;
b) accessing the stored data; and
c) in response to step b), automatically restricting further access to the data.

11. A method as claimed in claim 10, further comprising subsequent to step c), requesting entry of a password to enable access to data.

12. A method as claimed in claim 10, further comprising, before step a), receiving at least a portion of the data at the hand portable device.

13. A method as claimed in claim 10, wherein the access at step b) is a first access to the data by the hand portable device.

14. A method as claimed in of claims 10, further comprising: discriminating the type of a data, wherein the automatic restriction of further access at step c) is enabled only for data of a defined type or types.

15. A method as claimed in claim 14, further comprising user specification of the defined type(s) for which automatic restriction of further access is enabled.

16. A method as claimed in claim 10, further comprising: user specification of a password for a first security mechanism used to restrict the further access to the data.

17. A method as claimed in claims 10, wherein the data defines one of: a SMS message, a MMS message, an instant messaging history, a picture file; an audio file; a video file; or a collection of bookmarks.

18. A method as claimed in of claims 10, wherein the data is created in the device.

19. A method for controlling access rights to data stored in a hand portable device, wherein a data assemblage containing data for display as displayable content, is automatically password protected after the content is first displayed.

20. A method for controlling access rights to data stored in a hand portable device, comprising:
a) storing a plurality of data assemblages in the hand portable device;
b) storing at least one data attribute for each data assemblage;
c) changing the data attribute of a first data assemblage from a first type to a second type; and
d) in response to step c), automatically restricting further access to the first data assemblage using a first security mechanism.

21. A method as claimed in claim 20, wherein the first type of data attribute indicates that its associated data assemblage has not yet been accessed using the device and the second type of data attribute indicates that the associated data assemblage has been accessed using the device.

22. A method as claimed in claim 20, wherein the first type of data attribute indicates that its associated data assemblage has been received and is available for access and the second type of data attribute indicates that the associated data assemblage was not accessed when received.

23. A method as claimed in claim 20, further comprising:
e) changing the data attribute of a second data assemblage from a first type to a second type; and
f) in response to step e), automatically restricting further access to the second data assemblage using the first security mechanism.

24. A method as claimed in claims 20, further comprising user specification of at least the second type of attribute.

25. A hand-portable device, for providing controlled access to stored data assemblages, comprising:
user input means for user input of a password;
a memory for storing a first data assemblage and a second data assemblage;
access means for enabling a user to access the first data assemblage and the second data assemblage; and
access control means arranged to detect access to the first data assemblage and automatically restrict subsequent access to the first data assemblage using a first security mechanism involving the password and arranged to detect access to the second data assemblage and automatically restrict subsequent access to the second data assemblage using the first security mechanism involving the password.

26. A hand-portable device as claimed in claim 25, further comprising transceiver means for receiving a data assemblage at the hand portable device.

27. A hand-portable device as claimed in claim 25, wherein the access control means is arranged to restrict subsequent access to the first data assemblage after detecting a first access to the first data assemblage and is arranged to restrict subsequent access to the second data assemblage after detecting a first access to the second data assemblage.

28. A hand-portable device as claimed in of claim 25, wherein the access control means discriminates the type of a data assemblage, and automatically restricts subsequent access to that data assemblage using a first security mechanism, if the data assemblage is of a defined type or types.

29. A hand-portable device as claimed in claim 28, wherein the user input means is operable to enable a user to specify the defined type(s).

30. A hand-portable device as claimed in claim 25, wherein the user input means is operable to enable a user to specify the password.

31. A hand-portable device as claimed in any one of claim 25, wherein the first data assemblage is one of: a SMS message, a MMS message, an instant messaging history, a picture file; an audio file; a video file; or a collection of bookmarks and wherein the second data assemblage is one of: a SMS message, a MMS message, an instant messaging history, a picture file; an audio file; a video file; or a collection of bookmarks.

32. A hand-portable device as claimed in claim 25, wherein the first data assemblage and/or the second data assemblage is/are created in the device.

33. A hand-portable device, for providing controlled access to stored data assemblages, comprising:
user input means for user input of a password;
a memory for storing data;
access means for enabling a user to access the data; and
access control means arranged to detect access to the data and automatically restrict subsequent access to the data using a first security mechanism involving the password.

34. A hand-portable device as claimed in claim 33, further comprising transceiver means for receiving the data at the hand portable device.

35. A hand-portable device as claimed in claim 33, wherein the access control means is arranged to restrict subsequent access to the data after detecting a first access to the data.

36. A hand-portable device as claimed in claim 33, wherein the access control means discriminates the type of data, and automatically restricts subsequent access to data using the first security mechanism, if the data is of a defined type or types.

37. A hand-portable device as claimed in claim 36, wherein the user input means is operable to enable a user to specify the defined type(s).

38. A hand-portable device as claimed in of claim 33, wherein the user input means is operable to enable a user to specify the password.

39. A hand-portable device as claimed in claim 33, wherein the data defines one of: a SMS message, a MMS message, an instant messaging history, a picture file; an audio file; a video file; or a collection of bookmarks.

40. A hand-portable device as claimed in of claims 33, wherein the data are created in the device.

41. A hand-portable device, for providing controlled access to stored data assemblages, comprising:
user input means for user input of a password;
a memory for storing a plurality of data assemblages and a plurality of associated respective attributes;
access means for enabling a user to access a stored data assemblage; and
access control means arranged to automatically restrict subsequent access to a first data assemblage using a first security mechanism, after the data attribute of the first data assemblage changes from a first type to a second type.

42. A hand-portable device as claimed in claim 41 wherein the first type of attribute indicates that its associated data assemblage has not yet been accessed using the device and the second type of attribute indicates that its associated data assemblage has been accessed using the device.

43. A hand-portable device as claimed in claim 41, wherein the first type of attribute indicates that its associated data assemblage has been received and is available for access and the second type of attribute indicates that its associated data assemblage was not accessed when received.

44. A hand-portable device as claimed in claim 41, further wherein the access control means is arranged to automatically restrict subsequent access to a second data assemblage using a first security mechanism, when the data attribute of the second data assemblage changes from a first type to a second type.

45. A hand-portable device as claimed in claim 41, wherein the user input means enable user specification of at least the second type of attribute.

46. A computer program for enabling a mobile telephone to perform the method of claim 1.

47. A record carrier embodying a computer program as claimed in claim 46.

48. A computer program for enabling a mobile telephone to perform the method of claim 10.

49. A record carrier embodying a computer program as claimed in claim 48.

50. A computer program for enabling a mobile telephone to perform the method of claim 20.

51. A record carrier embodying a computer program as claimed in claim 50.
